(19) United States
(12) Patent Application Publication
(10) Pub. No.: US 2002/0181462 A1
(43) Pub. Date: Dec. 5, 2002

(54) System and method for providing end-to-end quality of service (QoS) across multiple internet protocol (IP) networks

(76) Inventors: Sorin Surdila, Laval (CA); George Foti, Dollard des Ormeaux (CA)

Correspondence Address: ERICSSON RESEARCH CANADA, 8400 DECARIE BLVD., MONTREAL, QC, H4P 2N2, CA

(21) Appl. No.: 09/841,752

(22) Filed: Apr. 24, 2001

(51) Int. Cl. H04L 12/28; H04L 12/56

(52) U.S. Cl. 370/392

(57) ABSTRACT

A system and method of ensuring a requested Quality of Service (QoS) for a media flow that is transported through multiple transport networks. An interface is established between a Call State Control Function (P-CSCF) and a Bandwidth Broker (BB) for the passing of a session description and Binding Information from the P-CSCF to the BB. The interface uses the Common Open Policy Service (COPS) protocol and the Bandwidth Broker (BB) protocol. The Binding Information may be the source IP address plus Real Time Protocol (RTP) port and the destination IP address plus RTP port. The Binding Information is also passed back toward the Originating BB (BB-O) from a Serving BB (BB-S) in the terminating (serving) network through BBs in adjacent networks using the BB protocol.

### BACKGROUND OF THE INVENTION

1. Technical Field of the Invention

This invention relates to telecommunication systems and, more particularly, to a system and method of providing End-to-End (E2E) Quality of Service (QoS) across multiple Internet Protocol (IP) networks.

2. Description of Related Art

Wireless telecommunication networks are evolving from second generation (2G) circuit-switched networks to third generation (3G) packet-switched networks. A Policy Framework and Architecture for third generation (3G) wireless Internet Protocol (IP) networks and the Internet is being developed by the Third Generation Partnership Project (3GPP). The purpose of the 3GPP Policy Framework and Architecture is to establish the real-time network control that is necessary to transform the Internet from a “best efforts” data network to a more reliable, real-time network. There are two releases of the proposal for 3G systems, but neither of the releases addresses the issue of providing proper control of network transport resources when a single application is utilized across several transport networks.

The first release, referred to as 3GPP Release 99, introduces some new radio access technology such as Wideband Code Division Multiple Access (CDMA) and Enhanced Data rates for GPRS Evolution (EDGE). Wideband CDMA introduces not only a new radio technology, but also Asynchronous Transfer Mode (ATM) technology in the radio access portion of the network. In the second 3G release called 3GPP Release 00, a real-time IP network is envisioned with all the infrastructure to carry real-time applications with equal or better quality than circuit-switched networks. It is assumed in Release 00 that the different administrative domains owning the transport resources are over-provisioned in order to ensure an end-to-end QoS to an application.

The Application Performance Rating Table below further illustrates the amount of bandwidth required for different types of applications in order to achieve certain levels of Quality of Service (QoS). For example, if high quality video is carried over an ISDN link at 128 kbps, the end user sees jerky, robotic movement (fair). However, if the video is provided at 384 kbps, the quality of the video is much better. At the other end of the performance spectrum, a voice call can be carried at 9.6 kbps and still have excellent voice quality. For efficient use of network resources, a control mechanism is needed to ensure that the right amount of bandwidth is provided in each transit network to deliver the requested E2E QoS without wasting excess bandwidth.

The support of E2E QoS is a very important issue related to the launching of real-time applications such as IP telephony, mixed voice/video calls, etc. over the IP infrastructure. The major challenge is to make sure that when a user requests a certain QoS, this QoS can be assured all the way to the recipient. The issue is complicated by the fact that in the general case, the payload path between two users can travel through multiple networks owned and operated by different operators who can choose various QoS solutions, other than over-provisioning, for their own domains.

Application Performance Rating Table

| Data Rates | | | | | | | |
|---|---|---|---|---|---|---|---|
| (kbps) | 9.6 | 14.4 | 32 | 64 | 128 | 384 | 2000 |
| Applications | Application Performance Rating | | | | | | |
| Voice, SMS | E | E | E | E | E | E | E |
| E-mail | P | F | E | E | E | E | E |
| Internet Web | P | P | F | F | E | E | E |
| Access | | | | | | | |
| Database Access | P | P | F | E | E | E | E |
| Synchronization | E | E | E | E | E | E | E |
| Document | P | P | F | E | E | E | E |
| Transfer | | | | | | | |
| Location | F | E | E | E | E | E | E |
| Services | | | | | | | |
| Still Image | P | F | E | E | E | E | E |
| Transfer | | | | | | | |
| Video Lower | P | F | F | E | E | E | E |
| Quality | | | | | | | |
| Video High | P | P | P | F | F | E | E |
| Quality | | | | | | | |

Excellent (E) Fair (F) Poor (P)

In order to overcome the disadvantage of existing solutions, it would be advantageous to have a system and method of ensuring a requested Quality of Service (QoS) for a media flow that is transported through multiple transport networks, even if they are owned by different administrations employing different QoS solutions. The present invention provides such a system and method.

### SUMMARY OF THE INVENTION

In one aspect, the present invention is a method of ensuring a requested Quality of Service (QoS) for a media flow that is routed from a first terminal in an originating network, through at least one transit network, to a second terminal in a terminating network. The originating network includes an Originating Bandwidth Broker (BB-O) and an Originating Media Policy Server (MPS-O). The transit network includes a Transit Bandwidth Broker (BB-T). The terminating network includes a Serving Bandwidth Broker (BB-S) and a Serving Media Policy Server (MPS-S). The method includes the steps of sending an origination message from the originating network to the terminating network with a proposed session description that identifies the requested QoS; determining by the terminating network that the session description is agreeable; and sending a first Resource Allocation Request (RAR) from the BB-S to the BB-T with binding information that identifies the first and second terminals and the requested QoS. The BB-T determines whether a Service Level Agreement (SLA) between the transit network and the terminating network allows sufficient resources to be allocated to meet the requested QoS. This is followed by sending a second RAR from the BB-T to the BB-O with the binding information, upon determining by the BB-T that the SLA between the transit network and the terminating network allows sufficient resources to be allocated to meet the requested QoS. The resources required to meet the requested QoS are then reserved in the originating network, the transit network, and the terminating network. A multimedia session is then set up to carry the media flow with the requested QoS.

In another aspect, the present invention is a Multimedia Control Server (MMCS) in a multi-service core network for ensuring a requested QoS for a media flow being routed from a first terminal in the core network to a second terminal in a terminating network. The MMCS includes an Originating Call State Control Function (known as a P-CSCF) that serves the first terminal; a BB-O that manages resources in the originating network; and a first interface between the P-CSCF and the BB-O for passing binding information from the P-CSCF to the BB-O. The binding information identifies the first and second terminals and the requested QoS. The MMCS also includes an Originating Media Policy Server (MPS-O) that provides policy rules regarding allocation of resources in the originating network, and a second interface between the MPS-O and the BB-O for passing the policy rules from the MPS-O to the BB-O. A third interface passes policy rules from the BB-O to a plurality of edge routers that route the media flow into and out of the originating network.

When the media flow originating from the first terminal is routed through a transport network owned by an administration, and the media flow is routed through at least one transit network that is not owned by the same administration, the MMCS may also include a fourth interface between the BB-O and a BB-T in the transit network for passing the binding information from the BB-T to the BB-O, the binding information having been received by the BB-T from a BB-S in the terminating network.

In yet another aspect, the present invention is a system for ensuring a requested QoS for a media flow from an application on a first terminal that is transported over network resources in an originating network owned by an administration, and is then routed through at least one transit network that is not owned by the same administration to a second terminal in a terminating network. The system includes a first MMCS in the originating network that comprises a P-CSCF that serves the first terminal; a BB-O that manages resources in the originating network; and a first interface between the P-CSCF and the BB-O for passing a session description and binding information from the P-CSCF to the BB-O. The binding information identifies the first and second terminals and the requested QoS. The system also includes an MPS-O that provides policy rules regarding allocation of resources in the originating network, and a second interface between the MPS-O and the BB-O for passing the policy rules to the BB-O. The system also includes a plurality of originating edge routers that route the media flow into and out of the originating network, and a third interface between the originating edge routers and the BB-O for passing policy rules from the BB-O to the originating edge routers.

A second MMCS in the terminating network comprises a Terminating Call State Control Function (P-CSCF) that serves the second terminal; a Serving Bandwidth Broker (BB-S) that manages resources in the terminating network; and a fourth interface between the P-CSCF and the BB-S for passing an agreed session description from the P-CSCF to the BB-S. A Serving Media Policy Server (MPS-S) provides policy rules regarding allocation of resources in the terminating network, and a fifth interface between the MPS-S and the BB-S passes the policy rules from the MPS-S to the BB-S. The system also includes a plurality of serving edge routers that route the media flow into and out of the terminating network, and a sixth interface between the serving edge routers and the BB-S for passing policy rules from the BB-S to the serving edge routers. The transit network includes a Transit Bandwidth Broker (BB-T). A seventh interface between the BB-S and the BB-T passes the binding information from the BB-S to the BB-T in a first Resource Allocation Request (RAR). An eighth interface between the BB-T and the BB-O passes the binding information from the BB-T to the BB-O in a second RAR. This ensures that the binding information is available and known to all domains supporting the application in the provision of end-to-end QoS.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a simplified block diagram of the QBone Phase 1 Bandwidth Broker (BB) Architecture;

FIG. 2 (Prior Art) is a simplified block diagram of the QBone Phase 2 BB Architecture;

FIG. 3 is a simplified block diagram of the preferred embodiment of the Phase 1 BB Architecture of the present invention;

FIGS. 4A-4B are portions of a sequence diagram illustrating implementation of a Push Policy Mechanism for End-to-End QoS for a SIP call during Phase 1;

FIGS. 5A-5B are portions of a sequence diagram illustrating implementation of a Pull Policy Mechanism for End-to-End QoS for a SIP call during Phase 1;

FIG. 6 is a simplified block diagram of the preferred embodiment of the Phase 2 BB Architecture of the present invention when there are BBs in every transit network;

FIGS. 7A-7B are portions of a sequence diagram illustrating implementation of a Push Policy Mechanism for End-to-End QoS for a SIP call during Phase 2 when there are BBs in every transit network;

FIG. 8 is a simplified block diagram of the preferred embodiment of the Phase 2 BB Architecture of the present invention when there are BBs in some, but not all, transit networks; and

FIGS. 9A-9B are portions of a sequence diagram illustrating implementation of a Push Policy Mechanism for End-to-End QoS for a SIP call during Phase 2 when there are BBs in some, but not all, transit networks.

### DETAILED DESCRIPTION OF EMBODIMENTS

QBone Working Group Architecture

A working group known as the QBone Working Group has defined, as part of the Internet 2 initiative, an architecture for coordinating bandwidth requirements across multiple networks at the transport level. The QBone group has published a description of the architecture in a paper entitled “QBone Bandwidth Broker Architecture” found at http://www.internet2.edu/qos/qbone/papers/sibbs/, and this paper is incorporated by reference in its entirety herein. This paper defines the functionality of a Bandwidth Broker (BB) and contains a brief specification of a BB protocol which is to be introduced in Phase 2 of the QBone implementation program.

The terms Bandwidth Broker, Network Control Point, and Bearer/Resource Manager are used interchangeably in the industry to refer to the same functional node, but Bandwidth Broker is currently preferred by the majority. As referred to herein, the BB does more than merely control bandwidth. Often, for example, an edge router will have the bandwidth available to carry a given application, but cannot carry the packets with the required latency to provide the desired QoS. Therefore, the BB instructs the edge router to deny access. This action is typically performed by having the BB install a policy in the edge router that denies the admission of the incoming flow. BBs do not exist today, but are proposed for the Internet Engineering Task Force (IETF) policy framework architecture in order to support a real-time IP network.

The BB is a server application. The BB understands all IP protocols such as the Routing Information Protocol (RIP). Therefore, it builds a database that allows the routers to understand the topology of the network it controls. It knows what paths in the network, by default, packets will use in crossing the network. It knows what nodes need to be controlled in order to ensure all of an application's packets flow through the network in such a way that they fulfill the appropriate Service Level Agreement (SLA).

The functions of the BB are to:

1. Know the QoS availability of the resources in the network it controls;

2. Receive all the requests for QoS and decide whether or not to accept them. This decision is based on various criteria such as resource availability, agreements with the downstream networks, network policies, subscriber rights, etc.

3. Make sure that the requested QoS is available end-to-end. To assure this, the BB may need to communicate with the BB's of neighboring networks to request the End-to-End QoS reservation.

4. Instruct specific routers in its network to install appropriate policies for treating the payload flows.

The QBone group has established a two-phase implementation of the end-to-end QoS solution. The distinction between Phase 1 and Phase 2 is that in QBone Phase 1, there will be BB's only in the multi-service core networks, but no BBs in the transit networks. It is assumed that the bandwidth capacity in the transit networks is dimensioned to cover all of the SLAs with the neighboring transport networks (either multi-service core or transit). In QBone Phase 2, BBs are implemented in all of the transit networks as well.

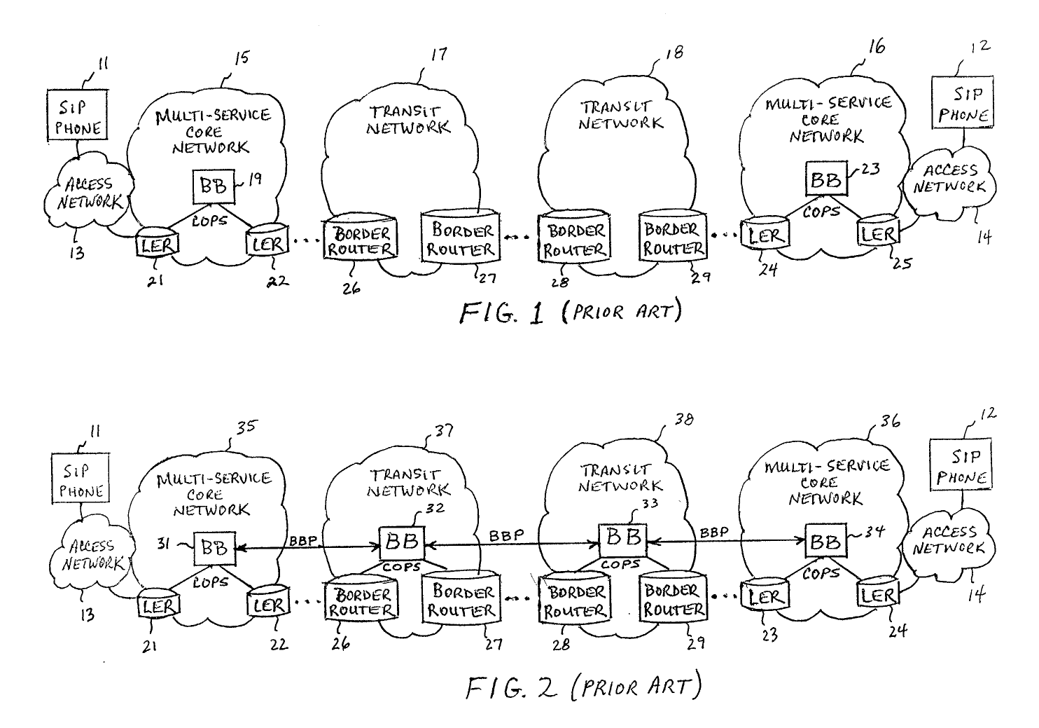

FIG. 1 is a simplified block diagram of the QBone Phase 1 Bandwidth Broker (BB) Architecture. In the illustrated configuration, a first Session Initiation Protocol (SIP) phone 11 is conducting a multimedia session with a second SIP phone 12. Access networks 13 and 14 are utilized to access Multi-Service Core Networks 15 and 16, respectively. The session is transported between the core networks through transit networks 17 and 18. Core network 15 includes a BB 19 which utilizes the Common Open Policy Service (COPS) protocol to communicate with Label Edge Routers (LERS) 21 and 22. The LERs function as edge routers that also insert a specific label in the data packets to identify a specific media flow at the entry to the network, and remove the label upon exiting the network. The Multi-Protocol Label Switching (MPLS) protocol then routes packets based on the labels inserted by the LERs rather than the IP addresses. Core network 16 likewise includes a BB 23 which utilizes the COPS protocol to communicate with LERs 24 and 25. The transit networks include border routers 26-29. The border routers do not do any labeling; they utilize the Differential Services (DiffServ) protocol for routing packets.

The marking and remarking of IP packets when transiting from one network to another is done by border routers at the entry point into the network (marking) and the exit point from the network (remarking). Optionally, and through administrative agreements, LERs can perform packet marking for transit networks utilizing DiffServ.

In Phase 1, there is no BB protocol. Moreover, the BB of the multi-service core network needs to install policies only in the ingress LERs 21 and 25 (the point of entrance of the access network traffic). It is assumed that the end-to-end QoS relies on sufficient Service Level Agreements (SLAs) and over-provisioning between the core network controlled by the BB and the other transit networks. In Phase 1, the two core networks 15 and 16 involved in a call will act as two separate islands. Therefore, for telephony calls, the bandwidth reservation inside these islands should be done for bidirectional flows.

FIG. 2 is a simplified block diagram of the QBone Phase 2 BB Architecture. In Phase 2, BBs are installed in all networks, and the BB protocol is introduced to link all the BBs. As illustrated, BBs 31-34 are modified to communicate with neighboring BBs using the BB protocol, and are installed in the Multi-Service Core Networks 35 and 36, and in the transit networks 37 and 38. BB 31 utilizes the COPS protocol to communicate with LERs 21 and 22 within the core network 35, and BB 34 utilizes the COPS protocol to communicate with LERs 23 and 24 within the core network 36. BB 32 utilizes the COPS protocol to communicate with border routers 26 and 27 within the transit network 37, and BE 33 utilizes the COPS protocol to communicate with border routers 28 and 29 within the transit network 38.

A problem with the QBone Architecture is that it is based on a transport-centric view which totally ignores the application that uses the transport resources, and ignores the interaction between the transport layers and the application layers. There is no binding between the applications and the transport resources allocated by those applications for providing end-to-end QoS. Collaboration between the applications and the transport layers has several benefits related to providing end-to-end QoS such as prevention of theft of the bearer, proper usage of the bearer for intended users, prevention of denial of service attacks, etc. Another problem with the QBone Phase 2 Architecture is that it assumes that all the networks in the payload path have a BB. However, this is not necessarily the case since many transit network operators may decide to use the Phase 1 solution for a long period of time in which no BB will be installed.

### ARCHITECTURE OF THE PRESENT INVENTION

The present invention provides proper control of network transport resources when a single application is utilized across several transport networks. Proper control includes the ability to bind the utilization of transport resources across several administrative domains to the application utilizing these resources for the provision of end-to-end QoS. This binding is necessary regardless of the QoS solution used in each administrative domain for the provision of end-to-end QoS. QoS solutions can include over-provisioning based on Service Level Agreements (SLAs) between different domains, centralized Bandwidth Brokers for control of transport resources, etc. The information to bind the application to the transport resources utilized by that application is referred to as “binding information”. The binding information must be unique for each application execution.

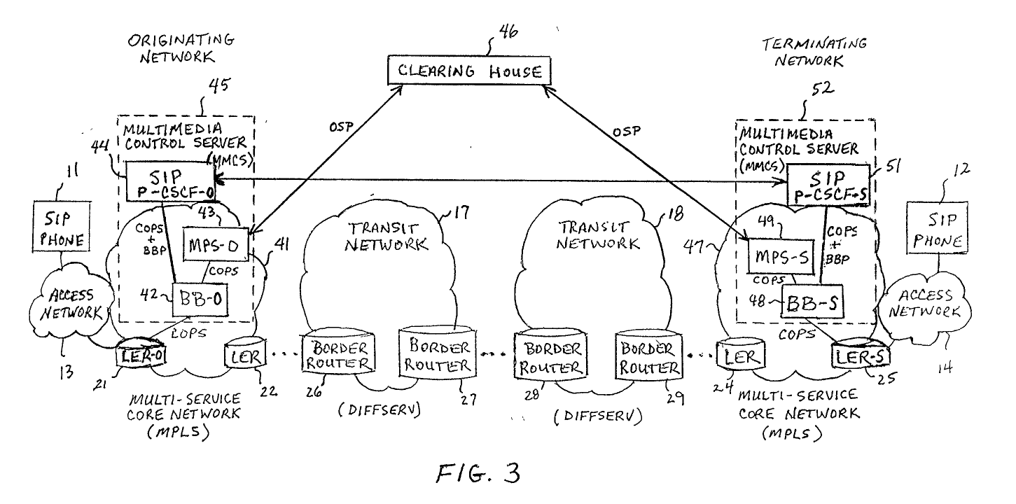

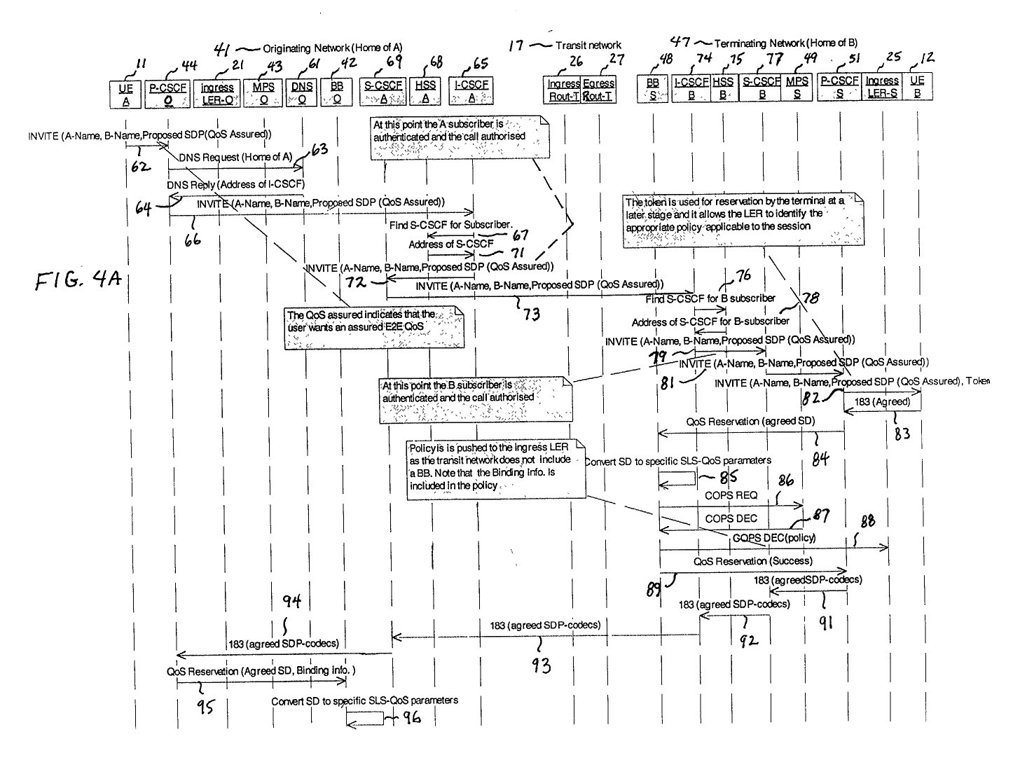

FIG. 3 is a simplified block diagram of the preferred embodiment of the Phase 1 BB Architecture of the present invention. For clarity, some network elements involved in session setup signaling have not been shown. Within an originating Multi-Service Core Network 41, a BB-O 42 interfaces with a Media Policy Server (MPS-O) 43 using the COPS protocol. Before talking to the LERs, the BB-O must first verify that the policy allows for media packets belonging to a specific session to be admitted. The MPS-O functions to enable the network operator to provide instructions on how the bandwidth in the network should be allocated. For example, the IETF has standardized four classes of services: Best Efforts, Interactive, Real-time Stream, and Conversational, and the operator may instruct that 25% of the available bandwidth be reserved for Best Efforts and Interactive traffic. The MPS-O also interfaces with a Clearing House 46 using the Open Systems Protocol (OSP). The Clearing House performs the functions of an IETF Authorization, Authentication, and Accounting (AAA) server.

The BB-O 42 also interfaces with an originating SIP CSCF (P-CSCF-O) 44 using a new link and a combination of the COPS protocol and the BB protocol (BBP). The interface between the P-CSCF-O 44 and the BB-O 42 provides a link between the control plane and the transport plane, and the combination of the BB-O 42, the MPS-O 43, and the P-CSCF-O 44 form a functional entity known as a Multimedia Control Server (MMCS) 45.

Within a terminating Multi-Service Core Network 47, a BB-S 48 interfaces with a Policy Server (MPS-S) 49 using the COPS protocol. The BB-S also interfaces with a terminating SIP CSCF (P-CSCF-S) 51 using a combination of the COPS protocol and BBP. The interface between the P-CSCF-S 51 and the BB-S 48 provides a link between the control plane and the transport plane, and the combination of the BB-S, the MPS-S, and the P-CSCF-S form an MMCS 52.

The present invention focuses on the BB protocol used between the BB and the Originating Call State Control Function (P-CSCF-O) serving the originating terminal, and proposes Binding Information that helps correlate a BB reservation session with an application session (e.g., SIP call establishment). Moreover, it defines the new BB behavior that takes into consideration this Binding Information.

Use of the Binding Information in the BB protocol along with the new BB behavior ensures that the benefits of collaboration (represented by the binding information) between the application and the transport layers will be realized. Use of the Binding Information also enables the establishment of a consistent migration path from Phase 1 onward by preserving the BB's behavior principles. In Phase 1, where a BB is implemented in each multi-service core network 41 and 47 for the two terminals (SIP phones 11 and 12) involved in the call, the two BBs behave as independent entities. When the corresponding CSCFs request a QoS reservation from the BBs, the BBs respond by focusing on their area of control, which is limited to their core networks.

When the P-CSCF-O 44 requests the BB-O 42 in the originating core network to reserve the QoS, the BB-O has to determine whether a reservation was previously made for the same media flow of the same session. This is only possible if there is certain information that allows it to check whether a previous reservation was made. This is the Binding Information which has to be carried by the BB protocol. The Binding Information must be carried in the SIP messages so that it can be transmitted from the P-CSCF-O 44 to the BB-O. However, since SIP is a mature protocol already implemented, the preferred embodiment of the present invention does not modify the SIP protocol to transport this information. With respect to the BB protocol, the preferred embodiment does not add a new parameter to transfer the information between BBs. With this in mind, the invention uses the session information carried by the Session Description Protocol (SDP) within the SIP signaling as the binding information to uniquely identify the flows for which the QoS reservation is performed. The invention then focuses on transferring the Binding Information within the BB protocol by using the Resource Allocation Request (RAR) ID parameter within the RAR message for that purpose. The RAR ID parameter already exists, but is currently of little use.

The preferred embodiment includes the source IP address plus an identification of a Real Time Protocol (RTP) port assigned by the originating terminal, along with the destination IP address plus an identification of an RTP port assigned by the destination terminal as the Binding Information in the BB protocol. This information, which is included in the SDP within the SIP signaling, is extracted by the BB-S 48 in the terminating network from the QoS reservation request received from the P-CSCF-O 44 as well as from the response returned from the destination.

When the Binding Information is being utilized, and a core network BB receives a Resource Allocation Request (RAR) from another BB, the core network BB:

1. Determines whether the SLA between the two networks allows this reservation.

2. Determines whether its network has available resources for this reservation.

3. Eventually installs the applicable policies in the selected routers.

4. Stores the Binding Information (resource and destination IP addresses and RTP ports) for the flow for which the QoS was requested. This information is received in the RAR.

5. Attaches a time stamp to the information to help detect stale reservations in the future.

6. Answers the RAR with a Resource Allocation Answer (RAA) message.

When the Binding Information is being utilized, and a core network BB receives a QoS reservation request containing the session's SDP from a CSCF server, the core network BB:

1. Checks whether there is any reservation already made for this session. The BB uses the source and destination IP addresses and the RTP ports extracted from the SDP (the Binding Information coming from the application layer).

2. If the BB finds another reservation already made for this set of addresses, the BB checks the time stamp to determine whether this reservation is stale. The network operator establishes a time interval as a threshold for considering a reservation stale.

3. The BB may also check for other possible mismatches between the actual request and the reservation already made.

4. If a valid reservation was already made, the BB immediately answers the CSCF's request with a successful reservation.

5. If no valid reservation is found, the BB proceeds with the procedure for reserving the requested QoS.

The BB maps the type of application and class of service to an SLA. The SLA specifies the characteristics that are needed to carry the packets that belong to a specific application such as the amount of bandwidth, delays, delay variation, and jitter. The BB translates the SLA to a Service Level Specification (SLS). The system must then enforce the SLS to ensure that the right QoS is provided end-to-end.

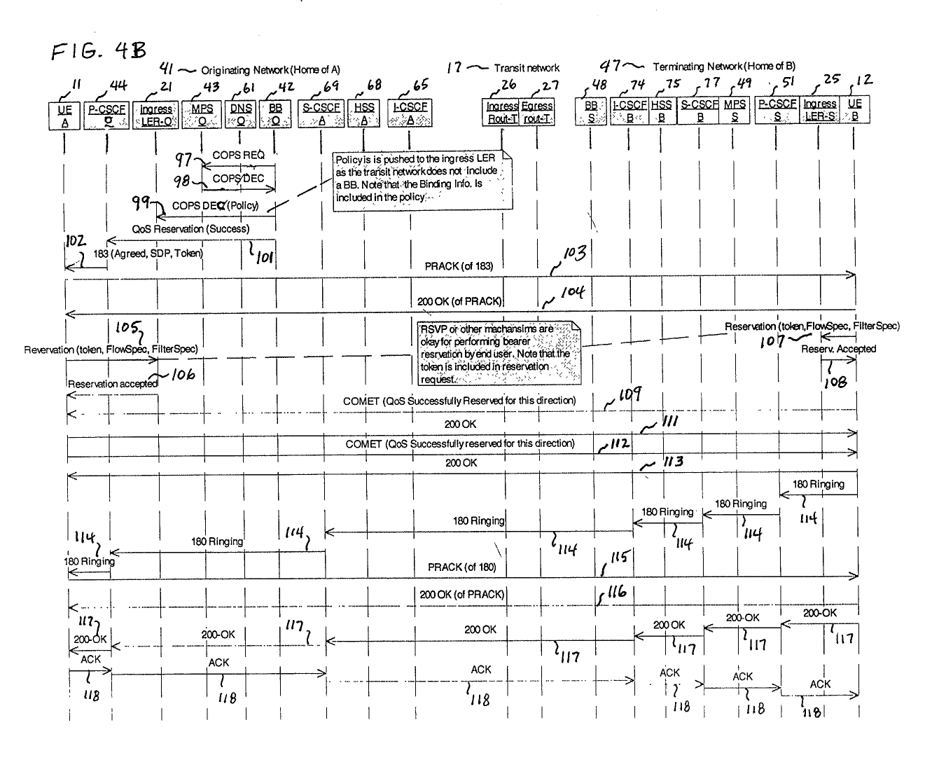

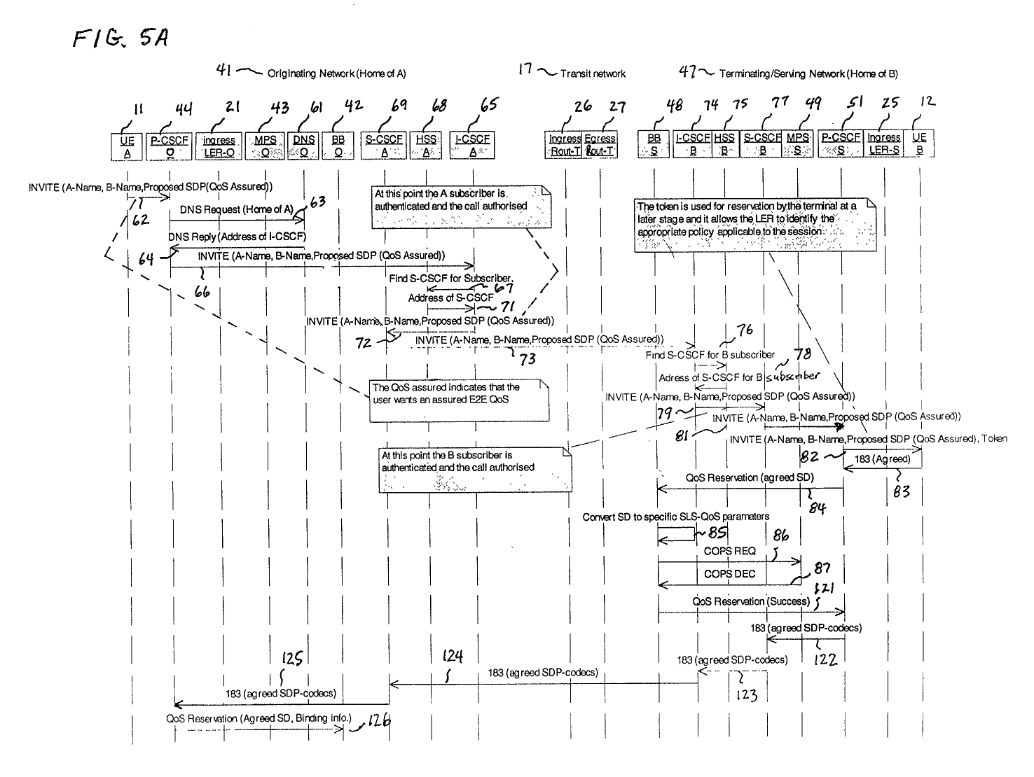

Looking specifically at Phase 1, the present invention defines both a Push Policy Mechanism and a Pull Policy Mechanism for ensuring end-to-end QoS. In the push mechanism, the policy is pushed to the routers at session setup while in the pull mechanism, the policy is dynamically retrieved (pulled) at reservation time. FIGS. 4A-4B are portions of a sequence diagram illustrating the implementation of a Push Policy Mechanism for End-to-End QoS for a SIP call during Phase 1 in which the originating network is the Multi-Service Core Network 41, and the terminating network is the Multi-Service Core Network 47 of FIG. 3. The media flows through a single transit network such as Transit Network 17. It is assumed that the originating and terminating users are roaming in their home networks. It is also assumed that the transit network is over-provisioned for handling traffic routed between the originating and terminating networks.

At step 62, End User (UE-A) 11 sends an Invite message to the Originating P-CSCF-O 44 and includes the A-Name, B-Name, and Proposed Session Description (SDP)(QoS Assured). Guaranteed end-to-end QoS is requested for the session, as indicated by the QoS Assured parameter in the SDP. The Originating P-CSCF-O proxies the Invite message to the home domain of the originating subscriber. To do so, the P-CSCF-O sends a Domain Name Server (DNS) Request 63 to an originating DNS (DNS-O) 61. The DNS-O sends a Reply at 64 identifying the IP address of an Interrogating CSCF (I-CSCF-A) 65 in the originating network. Following this, the Originating P-CSCF-O sends the Invite message 66 to the I-CSCF-A with the A-Name, B-Name, and Proposed SDP (QoS Assured).

At 67, the I-CSCF-A 65 requests UE-A's Home Subscriber Server (HSS) 68 to find the Serving CSCF (S-CSCF-A) 69 for UE-A 11. The HSS returns the address of the S-CSCF-A at 71, and the I-CSCF-A sends an Invite message 72 to the S-CSCF-A with the A-Name, B-Name, and Proposed SDP (QoS Assured). At this point, the UE-A is authenticated and the call is authorized. At 73, the S-CSCF-A, in turn, sends an Invite message to an Interrogating CSCF (I-CSCF-B) 74 in the terminating network 47. At 76, the I-CSCF-B requests UE-B's HSS 75 to find the Serving CSCF (S-CSCF-B) 77 for UE-B 12. The HSS returns the address of the S-CSCF-B at 78, and the I-CSCF-B sends an Invite message 79 to the S-CSCF-B with the A-Name, B-Name, and Proposed SDP (QoS Assured). At this point, the UE-B is authenticated and the call is authorized. Therefore, at 81, the S-CSCF-B sends an Invite message to the Terminating P-CSCF-S 51 with the A-Name, B-Name, and Proposed SDP (QoS Assured). At 82, the Terminating P-CSCF-S forwards the Invite message to the UE-B 12 with the Proposed SDP and includes an Authentication token. The token is used by the SIP client (UE-B) to make the QoS reservation at a later stage, and enables the LER-S to identify the appropriate policy applicable to the session.

At 83, the UE-B 12 sends a SIP 183 response message to the Terminating P-CSCF-S with an indication that the Session Description (SD) is agreed upon. At 84, the Terminating P-CSCF-S 51 requests a QoS Reservation with the Agreed SDP from the BB in the terminating network (BB-S) 48. At 85, the BB-S converts the Agreed SDP to specific SLS-QoS parameters, and then sets up the COPS link to the Policy Server (MPS-S) 49 with a COPS Request (COPS REQ) message 86. A COPS Decision (COPS DEC) message is returned at 87. At step 88, the BB-S 48 sends policy instructions to the ingress LER in the terminating network (LER-S) 25 to implement the terminating network's policy instructions. Thus, policy is pushed to the ingress LER-S since the transit network 17 does not include a BB. The policy instruction includes the Binding Information and the token that will be later used by the client to perform the actual reservation. The token enables the LER to identify the policy stored for the client.

A QoS Reservation Success message 89 is then sent from the BB-S to the Terminating P-CSCF-S 51. The Terminating P-CSCF-S then forwards the SIP 183 response message 91 to the S-CSCF-B 77 with the Agreed SDP and codecs. This message is forwarded to the I-CSCF-B 74 at step 92 which forwards it to the S-CSCF-A 69 in the originating network at 93. At 94, the S-CSCF-A forwards the 183 message to the Originating P-CSCF-O 44 with the Agreed SDP and codecs. The Originating P-CSCF-O then sends a QoS Reservation Request message 95 to the BB in the originating network (BB-O) 42 with the Agreed SDP and the Binding Information. At step 96, the BB-O converts the Agreed SD to specific SLS-QoS parameters, and the process then moves to FIG. 4B.

At steps 97-98, BB-O 42 sets up the COPS link to the Policy Server (MPS-O) 43 in the originating network. At step 99, the BB-O sends policy instructions to the ingress LER in the originating network (LER-O) 21 to implement the originating network's policy instructions. Thus, policy is pushed to the ingress LER-O since the transit network 17 does not include a BB. The policy instruction includes the Binding Information. A QoS Reservation (Success) message 101 is then sent from the BB-O to the Originating P-CSCF-O 44. The Originating P-CSCF-O then forwards the SIP 183 response message 102 to the UE-A 11 with the Agreed SDP and token.

At 103, the UE-A 11 sends a Provisional Acknowledgment (PRACK) message to the UE-B 12, and receives a SIP 200 OK message in response at 104. At 105, the UE-A sends a Reservation message to the ingress LER-O 21, and receives a Reservation accepted message in return at 106. The Reservation message includes the token, flow specification, and filter specification. The RSVP protocol or other mechanisms are acceptable for performing the bearer reservation by the end user. Likewise, at 107, the UE-B 12 sends a Reservation message to the ingress LER-S 25, and receives a Reservation accepted message in return at 108. Once again, the Reservation message includes the token, flow specification, and filter specification.

At 109, the UE-B 12 sends a Condition Met (COMET) message to the UE-A 11 indicating that the QoS has been successfully reserved for the direction from UE-B to UE-A. UE-A responds at 111 with a SIP 200 OK message. Likewise, at 112, the UE-A sends a COMET message to the UE-B indicating that the QoS has been successfully reserved for the direction from UE-A to UE-B. UE-B responds at 113 with a SIP 200 OK message. At 114, a SIP 180 Ringing message is then sent from the UE-B to UE-A via the Terminating P-CSCF-S 51, the S-CSCF-B 77, and the I-CSCF-B 74 in the terminating network 47, and via the S-CSCF-A 69 and the Originating P-CSCF-O 44 in the originating network 41.

At 115, the UE-A 11 sends a PRACK message to the SIP Client-B 12 in response to the 180 Ringing message. At 116, the UE-B sends a SIP 200 OK of the PRACK message to the UE-A. At 117, the UE-B sends a SIP 200 OK message to UE-A via the Terminating P-CSCF-S 51, the S-CSCF-B 77, and the I-CSCF-B 74 in the terminating network 47, and via the S-CSCF-A 69 and the Originating P-CSCF-O 44 in the originating network 41. The UE-A responds with an Acknowledgment message at 118, and the process of implementing a Phase 1 Push Policy Mechanism for end-to-end QoS is complete.

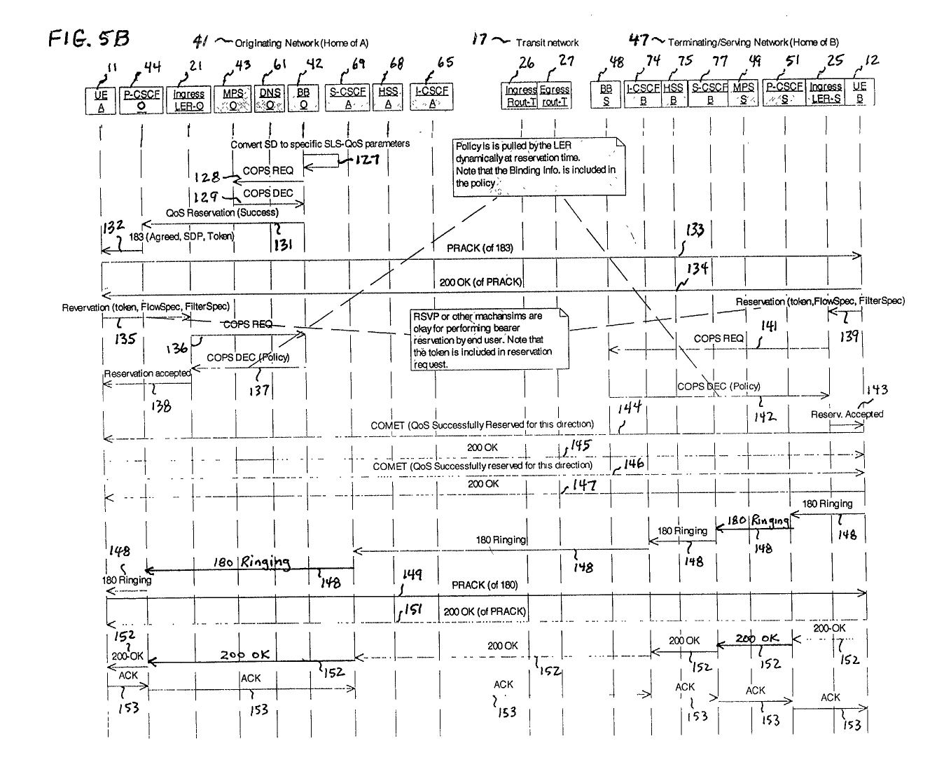

FIGS. 5A-5B are portions of a sequence diagram illustrating implementation of a Pull Policy Mechanism for End-to-End QoS for a SIP call during Phase 1. Again, it is assumed that the originating and terminating users are roaming in their home networks. The sequence is identical to that of FIGS. 4A-4B from steps 62 through 87. At that point, unlike FIGS. 4A-4B, policy is not pushed to the ingress LER. Instead, a QoS Reservation Success message 121 is then sent from the BB-S 48 to the Terminating P-CSCF-S 51. The Terminating P-CSCF-S then forwards the SIP 183 response message 122 to the S-CSCF-B 77 with the Agreed SDP and codecs. This message is forwarded to the I-CSCF-B 74 at step 123 which forwards it to the S-CSCF-A 69 in the originating network at 124. At 125, the S-CSCF-A forwards the 183 message to the Originating P-CSCF-O 44 with the Agreed SDP and codecs. The Originating P-CSCF-O then sends a QoS Reservation Request message 126 to the BB in the originating network (BB-O) 42 with the Agreed SDP and the Binding Information. The process then moves to FIG. 5B.

At step 127, the BB-O 42 converts the Agreed SDP to specific SLS-QOS parameters, and at steps 128-129, BB-O sets up the COPS link to the Policy Server (MPS-O) 43 in the originating network. A QoS Reservation (Success) message 131 is then sent from the BB-O to the Originating P-CSCF-O 44. The Originating P-CSCF-O then forwards the SIP 183 response message 132 to the UE-A 11 with the Agreed SDP and token.

At 133, the UE-A 11 sends a Provisional Acknowledgment (PRACK) message to the UE-B 12, and receives a SIP 200 OK message in response at 134. At 135, the UE-A sends a Reservation message to the ingress LER-O 21, and includes the token, flow specification, and filter specification. The LER-O sends a COPS REQ message 136 to the BB-O 42, and receives a COPS DEC message 137 in response that includes policy instructions and the Binding Information. Thus, policy is dynamically pulled from the BB-O by the ingress LER-O at reservation time. At 138, the LER-O sends a Reservation accepted message back to the UE-A. The RSVP protocol or other mechanisms are acceptable for performing the bearer reservation by the end user.

In a similar manner, the UE-B 12 sends a Reservation message 139 to the ingress LER-S 25, and includes the token, flow specification, and filter specification. The LER-S sends a COPS REQ message 141 to the BB-S 48, and receives a COPS DEC message 142 in response that includes policy instructions and the Binding Information. Thus, policy is dynamically pulled from the BB-S by the ingress LER-S at reservation time. At 143, the LER-S sends a Reservation accepted message back to the UE-B.

At 144, the UE-B 12 sends a Condition Met (COMET) message to the UE-A 11 indicating that the QoS has been successfully reserved for the direction from UE-B to UE-A. UE-A responds at 145 with a SIP 200 OK message. Likewise, at 146, the UE-A sends a COMET message to the UE-B indicating that the QoS has been successfully reserved for the direction from UE-A to UE-B. UE-B responds at 147 with a SIP 200 OK message. At 148, a SIP 180 Ringing message is then sent from the UE-B to UE-A via the Terminating P-CSCF-S 51, the S-CSCF-B 77, and the I-CSCF-B 74 in the terminating network 47, and via the S-CSCF-A 69 and the Originating P-CSCF-O 44 in the originating network 41.

At 149, the UE-A 11 sends a PRACK message to the UE-B 12 in response to the 180 Ringing message. At 151, the UE-B sends a SIP 200 OK of the PRACK message to the UE-A. At 152, the UE-B sends a SIP 200 OK message to UE-A via the Terminating P-CSCF-S 51, the S-CSCF-B 77, and the I-CSCF-B 74 in the terminating network 47, and via the S-CSCF-A 69 and the Originating P-CSCF-O 44 in the originating network 41. The UE-A responds with an Acknowledgment message at 153, and the process of implementing a Phase 1 Pull Policy Mechanism for end-to-end QoS is complete.

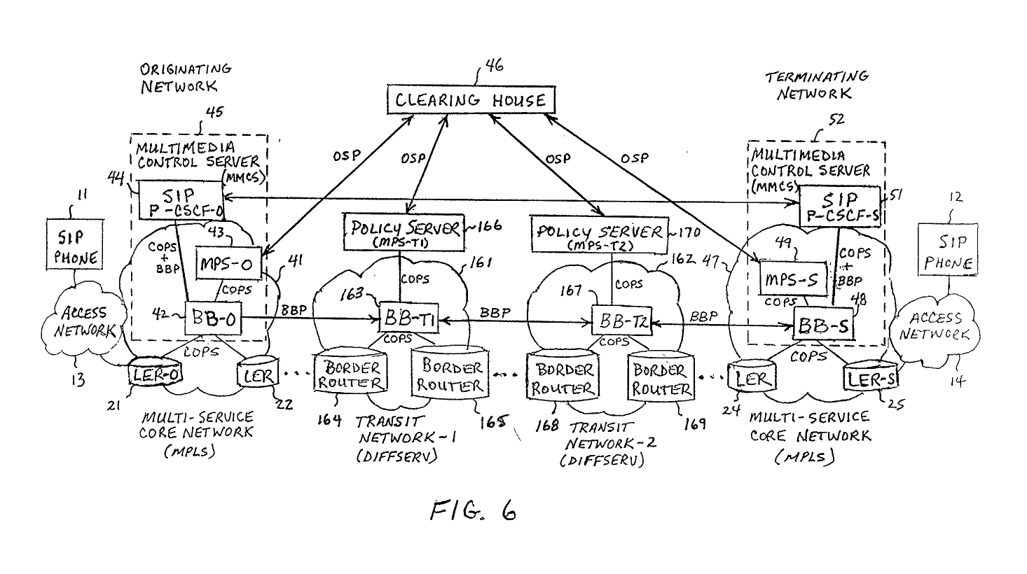

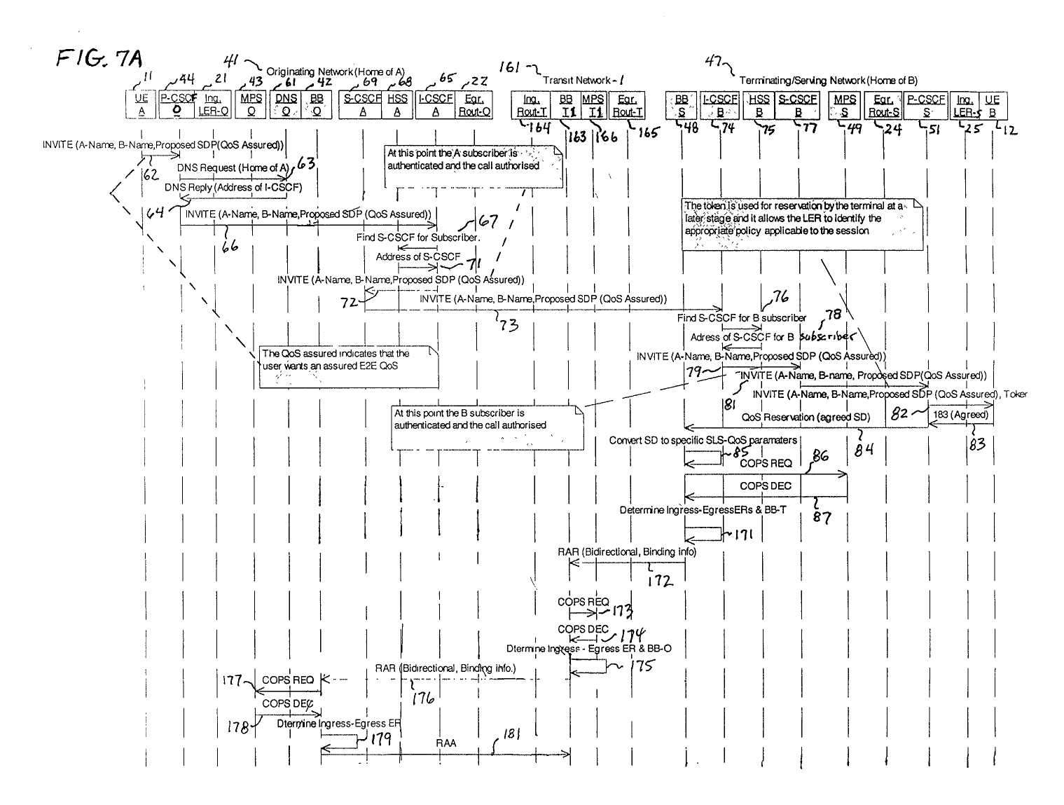

FIG. 6 is a simplified block diagram of the preferred embodiment of the Phase 2 BB Architecture of the present invention when there are BBs in every transit network. Thus, FIG. 6 is similar to FIG. 3 except that BBs have been implemented in Transit Network-1 161 and Transit Network-2 162. Within Transit Network-1, BB-T1 163 interfaces with border routers 164 and 165 using the COPS protocol. The BB-T1 also uses the COPS protocol to interface with a Policy Server (MPS-T1) 166. Within Transit Network-2, BB-T2 167 interfaces with border routers 168 and 169 using the COPS protocol. The BB-T2 also uses the COPS protocol to interface with a Policy Server (MPS-T2) 170. All of the network Policy Servers interface with the Clearing House 46 using the OSP protocol.

In Phase 2, the BBs in the two core networks will behave similarly, with the difference being that their area of control may be extended to consider the BBs in adjacent networks. However, in scenarios such as when the BB-S 48 in the terminating serving core network sends a request to the adjacent BB-T2 167 in a transit network, the BB-S does not know whether this request is propagated beyond BB-T2 all the way to the BB-O 42 of the originating core network. In the case where there are BBs in all of the intermediate transit networks, then the QoS reservation is propagated all the way to the BB-O in the originating core network. However, if all of the intermediate transit networks do not have a BB, then the originating core network BB-O does not receive the reservation initiated by the BB-S in the terminating core network.

In Phase 2, the SLA slightly changes its meaning from the perspective of the network playing the “customer” role. Using an analogy to financial markets, it becomes like an option. The customer gets the option to reserve the resources agreed to in the SLA, but the resources are not necessarily used all the time. When the customer wants to reserve some resources it has to send an RAR to the BB of the transit domain, and it will be charged only for the time the reservation is active. The Phase 2 End-to-End QoS mechanisms and the interactions between session layer and transport layer to allow End-to-End QoS evolve from those used in Phase 1.

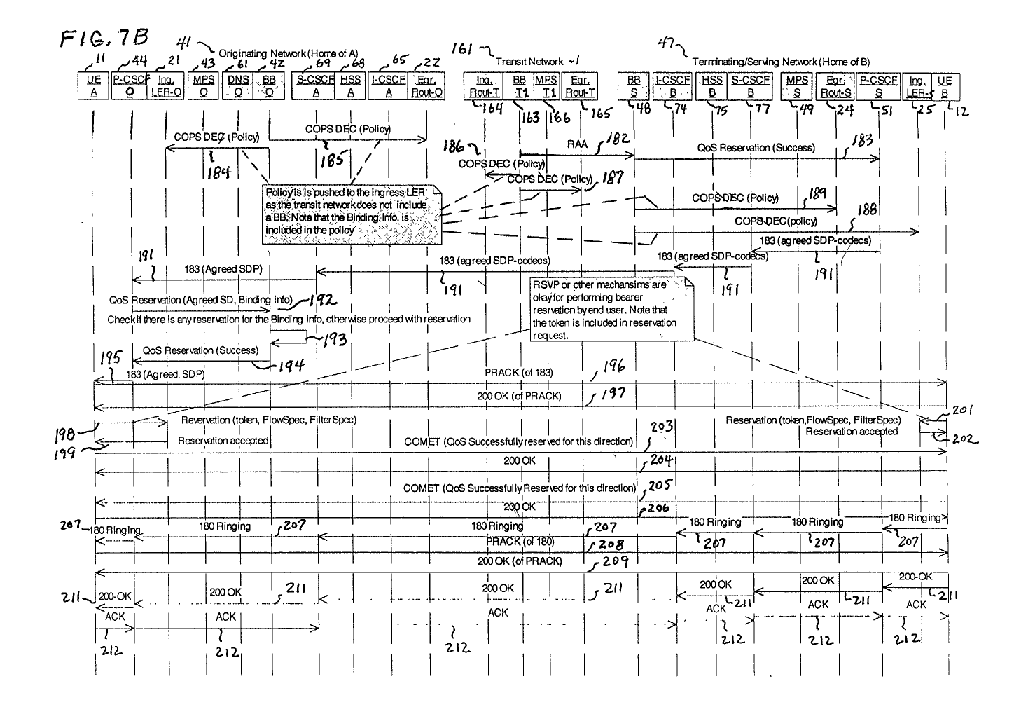

FIGS. 7A-7B are portions of a sequence diagram illustrating implementation of a Push Policy Mechanism for End-to-End QoS for a SIP call during Phase 2 when there are BBs in every transit network, as illustrated in FIG. 6. FIGS. 7A-7B illustrate setup with a single transit network such as Transit Network-1 161. It is assumed that the BBs in the multi-service core networks are upgraded with new software that supports the inter-domain BB protocol and the associated BB behavior.

The sequence is identical to that of FIGS. 4A-4B from steps 62 through 87. At that point, step 171, the BB-S 48 determines the ingress-egress edge routers and BB-T1 163. At 172, the BB-S sends a Resource Allocation Request (RAR) message to the BB-T1 163 indicating a bidirectional session and including the Binding Information. BB-T1 sends a COPS REQ message 173 to its Policy Server (MPS-T1) 166 and receives a COPS DEC message 174 in response. At 175, BB-T1 then determines the ingress-egress edge routers and BB-O 42. At 176, the BB-T1 sends an RAR message to the BB-O indicating a bidirectional session and including the Binding Information. BB-O sends a COPS REQ message 177 to its Policy Server (MPS-O) 43 and receives a COPS DEC message 178 in response. At 179, BB-O then determines the ingress-egress edge routers, and sends a Resource Allocation Answer (RAA) message 181 to BE-T1 163. The process then moves to FIG. 7B.

At 182, BB-T1 163 sends the RAA message to BB-S 48. BB-S then sends a QoS Reservation (Success) message 183 to the Terminating P-CSCF-S 51. Policy instructions and Binding Information are then pushed by the BBs in each network to their ingress and egress routers. Thus, at 184 and 185, BB-O 42 sends COPS DEC messages to the ingress LER-O 21 and the egress Rout-O 22. Likewise, BB-T1 163 sends COPS DEC messages 186 and 187 to the ingress Rout-T 164 and the egress Rout-T 165. Likewise, BB-S 48 sends COPS DEC messages 188 and 189 to the ingress LER-S 25 and the egress Rout-S 24.

The Terminating P-CSCF-S 51 then forwards the SIP 183 message 191 to the Originating P-CSCF-O 44 in the originating network with the agreed SDP and codecs. The 183 message is sent via the S-CSCF-B 77, the I-CSCF-B 74, and the S-CSCF-A 69. After receiving the SIP 183 message, the Originating P-CSCF-O behaves as in Phase 1: it requests the BB-O 42 to perform the bidirectional reservation by sending a QoS Reservation Request message 192 to the BB-O with the agreed SDP and Binding Information. The BB-O first checks at step 193 to determine whether any reservation was already made for this binding. If not, the BB-O proceeds with the QoS reservation. In this scenario, however, the reservation was already made, so BB-O answers the Originating P-CSCF's request immediately with a QoS Reservation Success message 194. The Originating P-CSCF-O then forwards the SIP 183 response message 195 to the UE-A 11 with the Agreed SDP and token.

At 196, the UE-A 11 sends a PRACK message to the UE-B 12, and receives a SIP 200 OK message 197 in response. At 198, the UE-A sends a Reservation message to its Ingress LER-O 21, and includes the token, flow specification, and filter specification. The LER-O sends a Reservation Accepted message in return at 199. Likewise, at 201, the UE-B 12 sends a Reservation message to its Ingress LER-S 25, and includes the token, flow specification, and filter specification. The LER-S sends a Reservation Accepted message in return at 202.

At 203, the UE-A 11 sends a Condition Met (COMET) message to the UE-B 12 indicating that the QoS has been successfully reserved for the direction from UE-A to UE-B. UE-B responds at 204 with a SIP 200 OK message. Likewise, at 205, the UE-B sends a COMET message to the UE-A indicating that the QoS has been successfully reserved for the direction from UE-B to UE-A. UE-A responds at 206 with a SIP 200 OK message. At 207, a SIP 180 Ringing message is then sent from the UE-B to UE-A via the Terminating P-CSCF-S 51, the S-CSCF-B 77, and the I-CSCF-B 74 in the terminating network 47, and via the S-CSCF-A 69 and the Originating P-CSCF-O 44 in the originating network 41.

At 208, the UE-A 11 sends a PRACK message to the UE-B 12 in response to the 180 Ringing message. At 209, the UE-B sends a SIP 200 OK of the PRACK message to the UE-A. At 211, the UE-B sends a SIP 200 OK message to UE-A via the Terminating P-CSCF-S 51, the S-CSCF-B 77, and the I-CSCF-B 74 in the terminating network 47, and via the S-CSCF-A 69 and the Originating P-CSCF-O 44 in the originating network 41. The UE-A responds with an Acknowledgment message at 212, and the process is complete for implementing a Push Policy Mechanism for End-to-End QoS for a SIP call during Phase 2 when there are BBs in every transit network.

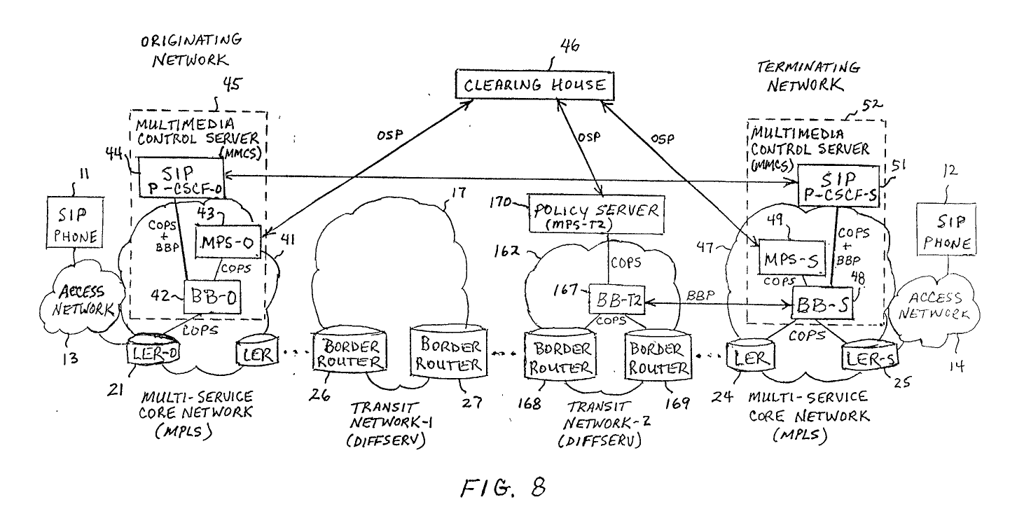

FIG. 8 is a simplified block diagram of the preferred embodiment of the Phase 2 BB Architecture of the present invention when there are BBs in some, but not all, transit networks. Although the transit networks will start introducing BB's in Phase 2, it is still possible to have some transit networks with no BB, either because those networks use over-dimensioning to ensure adequate bandwidth, or because the operators want to keep the same philosophy as in Phase 1. Thus, FIG. 8 is similar to FIG. 6 except that no BB has been implemented in Transit Network-1 17.

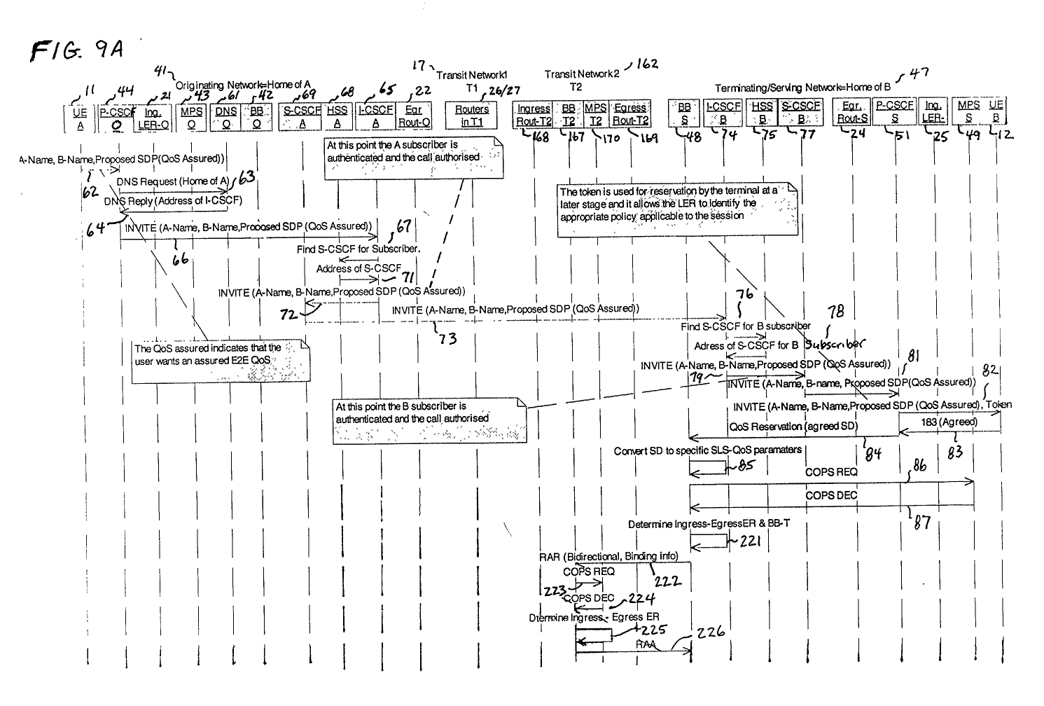

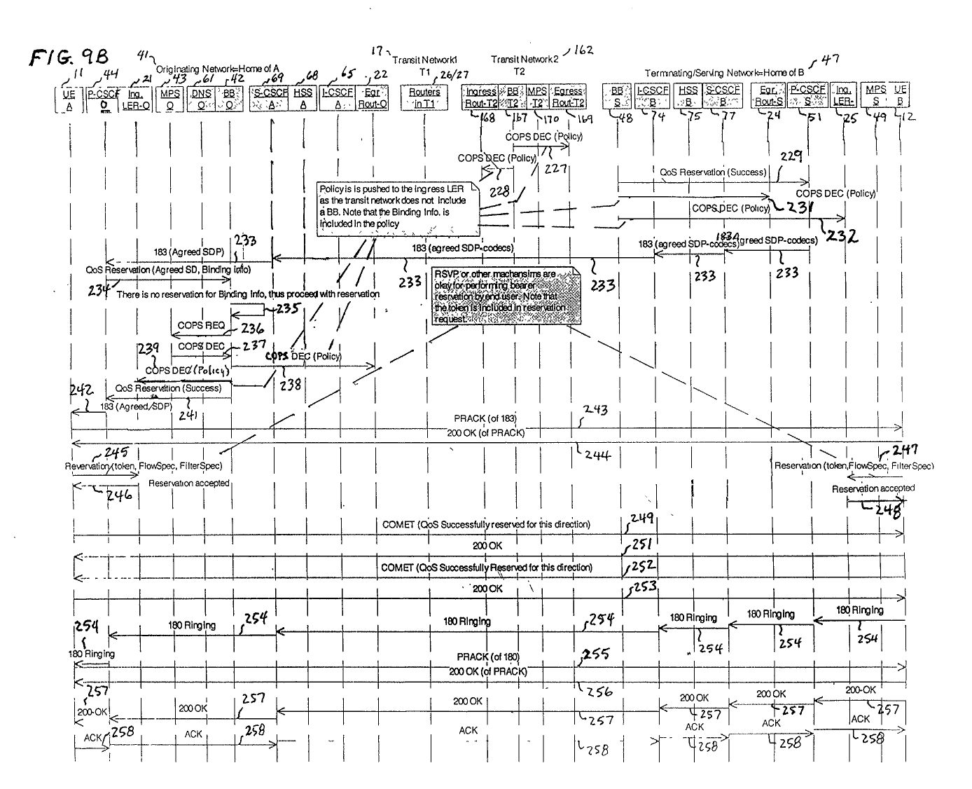

FIGS. 9A-9B are portions of a sequence diagram illustrating implementation of a Push Policy Mechanism for End-to-End QoS for a SIP call during Phase 2 when there are BBs in some, but not all, transit networks. The sequence is identical to that of FIGS. 4A-4B from steps 62 through 87. At that point, step 221, the BB-S 48 determines the ingress-egress edge routers and BB-T2 167. At 222, the BB-S sends a Resource Allocation Request (RAR) message to the BB-T2 indicating a bidirectional session and including the Binding Information. BB-T2 sends a COPS REQ message 223 to its Policy Server (MPS-T2) 170 and receives a COPS DEC message 224 in response. At 225, BB-T2 then determines the ingress-egress edge routers.

The bidirectional reservation started by BB-S 48 with the RAR message 222, does not reach the BB-O 42 because Transit Network-1 17 does not have a BB. In Transit Network-2 162, BB-T2 167 knows that there is no BB in Transit Network-1, so it does not attempt to send an RAR towards it. Instead, BB-T2 responds to the RAR 222 received from BB-S by making sure that the SLA with Transit Network-1 accommodates this traffic. BB-T2 then sends an RAA message 226 back to BB-S. The process then moves to FIG. 9B.

At step 227, BB-T2 sends a COPS DEC message to its egress Router 169, and at 228 sends a COPS DEC message to its ingress Router 168 with policy instructions and the Binding Information for Transit Network-2 162. Thus, policy is pushed to the edge routers of the Transit Network-2. The BB-S 48 then sends a QoS Reservation (Success) message 229 to the Terminating P-CSCF-S 51. At this time, the BB-S also sends a COPS DEC message 231 to its egress Router 24, and sends a COPS DEC message 232 to its ingress LER-S 25 with policy instructions and the Binding Information for the terminating network 47. Thus, policy is pushed to the edge routers of the terminating network. The Terminating P-CSCF-S then forwards the SIP 183 message 233 to the Originating P-CSCF-O 44 in the originating network with the agreed SDP and codecs.

At 234, the Originating P-CSCF-O 44 sends a QoS Reservation Request message to the BB-O 42 with the agreed SDP and the Binding Information. As a result of the request received from the Originating P-CSCF-O, the BB-O checks at step 235 to determine whether there is any reservation already made for that Binding Information. Since no reservation was made, BB-O proceeds with the QoS reservation as in Phase 1. The BB-O sends a COPS REQ message 236 to the MPS-O 43, and receives a COPS DEC message 237 in response. BB-O then sends a COPS DEC message 238 to the egress router 22, and sends a COPS DEC message 239 to the ingress LER-O 21 with policy instructions and the Binding Information for the originating network 41. Thus, policy is pushed to the edge routers of the originating network. For the scenario described in FIG. 9, the BB-O may be a Phase 1 BB.

At 241, the BB-O 42 answers the Originating P-CSCF's QoS Reservation request with a QoS Reservation (Success) message. The Originating P-CSCF-O then forwards the SIP 183 response message 242 to the UE-A 11 with the Agreed SDP and token. At 243, the UE-A 11 sends a PRACK message to the UE-B 12, and receives a SIP 200 OK message 244 in response. At 245, the UE-A sends a Reservation message to its Ingress LER-O 21, and includes the token, flow specification, and filter specification. The LER-O sends a Reservation Accepted message in return at 246. Likewise, at 247, the UE-B 12 sends a Reservation message to its Ingress LER-S 25, and includes the token, flow specification, and filter specification. The LER-S sends a Reservation Accepted message in return at 248.

At 249, the UE-A 11 sends a COMET message to the UE-B 12 indicating that the QoS has been successfully reserved for the direction from UE-A to UE-B. UE-B responds at 251 with a SIP 200 OK message. Likewise, at 252, the UE-B sends a COMET message to the UE-A indicating that the QoS has been successfully reserved for the direction from UE-B to UE-A. UE-A responds at 253 with a SIP 200 OK message. At 254, a SIP 180 Ringing message is then sent from the UE-B to UE-A via the Terminating P-CSCF-S 51, the S-CSCF-B 77, and the I-CSCF-B 74 in the terminating network 47, and via the S-CSCF-A 69 and the Originating P-CSCF-O 44 in the originating network 41.

At 255, the UE-A 11 sends a PRACK message to the UE-B 12 in response to the 180 Ringing message. At 256, the UE-B sends a SIP 200 OK of the PRACK message to the UE-A. At 257, the UE-B sends a SIP 200 OK message to UE-A via the Terminating P-CSCF-S 51, the S-CSCF-B 77, and the I-CSCF-B 74 in the terminating network 47, and via the S-CSCF-A 69 and the Originating P-CSCF-O 44 in the originating network 41. The UE-A responds with an Acknowledgment message at 258, and the process is complete for implementing a Push Policy Mechanism for End-to-End QoS for a SIP call during Phase 2 when there are BBs in some, but not all, transit networks.

Is also possible to have cases with three or more transit networks where the middle networks do not have BB's. In that case, the transit network which is the neighbor to the originating core network may be Phase-2 upgraded with a BB. Then the BB-O should be Phase-2 upgraded. The reservation triggered by the Originating P-CSCF-O then goes from BB-O, through BB-T1 up to the middle transit network, which has no BB.

It can be seen from the foregoing description that the Binding Information, as described, is being consistently utilized in all scenarios, regardless of the QoS solution deployed in a specific domain.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. A method of ensuring a requested Quality of Service (QoS) for a media flow that is routed from a first terminal in an originating network, through at least one transit network, to a second terminal in a terminating network, said originating network including an Originating Bandwidth Broker (BB-O) and an Originating Media Policy Server (MPS-O), said transit network including a Transit Bandwidth Broker (BB-T) and a Transit Media Policy Server (MPS-T), and said terminating network including a Serving Bandwidth Broker (BB-S) and a Serving Media Policy Server (MPS-S), said method comprising the steps of:
sending an origination message from the originating network to the terminating network with a proposed session description that identifies the requested QoS;
determining by the terminating network that the session description is agreeable;
sending a first Bandwidth Broker Protocol Resource Allocation Request (RAR) from the BB-S to the BB-T with binding information that identifies the first and second terminals and the requested QoS;
determining by the BB-T whether a Service Level Agreement (SLA) between the transit network and the terminating network allows sufficient resources to be allocated to meet the requested QoS;
sending a second RAR from the BB-T to the BB-O with the binding information, upon determining by the BB-T that the SLA between the transit network and the terminating network allows sufficient resources to be allocated to meet the requested QoS;
reserving the resources required to meet the requested QoS in the originating network, the transit network, and the terminating network; and
setting up a multimedia session to carry the media flow with the requested QoS.

2. The method of ensuring a requested QoS for a media flow of claim 1 further comprising, after the step of sending a second RAR from the BB-T to the BB-O with the binding information, the steps of:
sending a first Resource Allocation Answer (RAA) from the BB-O to the BB-T;
sending a second RAA from the BB-T to the BB-S; and
installing by the BB-O, the BB-T, and the BB-S, applicable policies in edge routers to provide the requested QoS in the originating network, the transit network, and the terminating network, respectively.

3. The method of ensuring a requested QoS for a media flow of claim 2 further comprising, before the step of reserving the resources required to meet the requested QoS, the steps of:
sending a QoS reservation request that includes the agreed session description and the binding information from an Originating Call State Control Function (Originating P-CSCF) to the BB-O;
determining by the BB-O whether a previous valid resource reservation exists for the session associated with the binding information; and
sending an immediate successful reservation response from the BB-O to the Originating P-CSCF, upon determining that a previous valid resource reservation exists for the session associated with the binding information.

4. The method of ensuring a requested QoS f or a media flow of claim 3 further comprising the steps of:
reserving resources required for the requested QoS, upon determining that a previous valid resource reservation does not exist for the session associated with the binding information.

5. The method of ensuring a requested QoS for a media flow of claim 4 wherein the step of determining by the BB-O whether a previous valid resource reservation exists includes the steps of:
determining whether a previous resource reservation was made for the session associated with the binding information; and
upon determining that a previous resource reservation was made, determining from a time stamp associated with the previous reservation whether the previous reservation is still valid.

6. The method of ensuring a requested QoS for a media flow of claim 3 wherein the step of sending the QoS reservation request from the Originating P-CSCF to the BB-O includes sending the QoS reservation request utilizing a Common Open Policy Service (COPS) protocol and a Bandwidth Broker protocol.

7. The method of ensuring a requested QoS for a media flow of claim 1 further comprising the step of creating the binding information from a source Internet Protocol (IP) address of the first terminal, an identification of a Real Time Protocol (RTP) port assigned by the first terminal, a destination IP address of the second terminal, and an identification of an RTP port assigned by the second terminal.

8. A Multimedia Control Server (MMCS) in a multi-service core network for ensuring a requested Quality of Service (QoS) for a media flow being routed from a first terminal in the core network to a second terminal in a terminating network, said MMCS comprising:
an Originating Call State Control Function (Originating P-CSCF) that serves the first terminal;
an Originating Bandwidth Broker (BB-O) that manages resources in the originating network;
a first interface between the Originating P-CSCF and the BB-O for passing binding information from the Originating P-CSCF to the BB-O, the binding information identifying the first and second terminals and the requested QoS;
an Originating Media Policy Server (MPS-O) that provides policy rules regarding allocation of resources in the originating network;
a second interface between the MPS-O and the BB-O for passing the policy rules from the MPS-O to the BB-O; and
a third interface between the BB-O and a plurality of edge routers that route the media flow into and out of the originating network, said third interface for passing from the BB-O to the edge routers, policy rules applicable to a specific media flow.

9. A Multimedia Control Server (MMCS) in a multi-service core network for ensuring a requested Quality of Service (QoS) for a media flow from an application on a first terminal that is transported through a network owned by an administration, said media flow being routed through at least one transit network that is not owned by the same administration, to a second terminal in a terminating network, said MMCS comprising:
an Originating Call State Control Function (Originating P-CSCF) that serves the first terminal;
an Originating Bandwidth Broker (BB-O) that manages resources in the originating network;
a first interface between the Originating P-CSCF and the BB-O for passing a session description and binding information from the Originating P-CSCF to the BB-O, the binding information identifying the first and second terminals and the requested QoS;
an Originating Media Policy Server (MPS-O) that provides policy rules regarding allocation of resources in the originating network;
a second interface between the MPS-O and the BB-O for passing the policy rules from the MPS-O to the BB-O;
a third interface between the BB-O and a plurality of edge routers that route the media flow into and out of the originating network, said third interface for passing from the BB-O to the edge routers, policy rules applicable to a specific media flow; and
a fourth interface between the BB-O and a Transit Bandwidth Broker (BB-T) in the transit network for passing the binding information from the BB-T to the BB-O, said binding information having been received by the BB-T from a Serving Bandwidth Broker (BB-S) in the terminating network.

10. The MMCS of claim 9 further comprising a fifth interface between the MPS-O and a clearing house that performs as an Authorization, Authentication, and Accounting (AAA) server.

11. A system for ensuring a requested Quality of Service (QoS) for a media flow belonging to an application and originating in an originating network owned by an administration, said media flow being routed from a first terminal in the originating network through at least one transit network that is not owned by the same administration, to a second terminal in a terminating network, said system comprising:
a first Multimedia Control Server (MMCS) in the originating network comprising:
an Originating Call State Control Function (Originating P-CSCF) that serves the first terminal;
an Originating Bandwidth Broker (BB-O) that manages resources in the originating network;
a first interface between the Originating P-CSCF and the BB-O for passing a session description and binding information from the Originating P-CSCF to the BB-O, the binding information identifying the first and second terminals and the requested QoS;
an Originating Media Policy Server (MPS-O) that provides policy rules regarding allocation of resources in the originating network;
a second interface between the MPS-O and the BB-O for passing the policy rules to the BB-O;
a plurality of originating edge routers that route the media flow into and out of the originating network;
a third interface between the originating edge routers and the BB-O for passing policy rules applicable to specific media flows from the BB-O to the originating edge routers;
a second MMCS in the terminating network comprising:
a Serving Call State Control Function (Terminating P-CSCF) that serves the second terminal;
a Serving Bandwidth Broker (BB-S) that manages resources in the terminating network;
a fourth interface between the Terminating P-CSCF and the BB-S for passing an agreed session description from the Terminating P-CSCF to the BB-S;
a Serving Media Policy Server (MPS-S) that provides policy rules regarding allocation of resources in the terminating network;
a fifth interface between the MPS-S and the BB-S for passing the policy rules from the MPS-S to the BB-S;
a plurality of serving edge routers that route the media flow into and out of the terminating network;
a sixth interface between the serving edge routers and the BB-S for passing policy rules applicable to specific media flows from the BB-S to the serving edge routers;
a Transit Bandwidth Broker (BB-T) in the transit network;
a seventh interface between the BB-S and the BB-T for passing the binding information from the BB-S to the BB-T in a first Resource Allocation Request (RAR); and
an eighth interface between the BB-T and the BB-O for passing the binding information from the BB-T to the BB-O in a second RAR.
